(19) United States
(12) Patent Application Publication
(10) Pub. No.: US 2014/0049376 A1
(43) Pub. Date: Feb. 20, 2014

(54) ATTACHABLE DEVICE SUPPORT WITH A COMMUNICATION MEANS

(71) Applicant: Boon Hwee Burnette Ng, Singapore (SG)

(72) Inventor: Boon Hwee Burnette Ng, Singapore (SG)

(21) Appl. No.: 13/989,354

(22) PCT Filed: Nov. 30, 2011
(86) PCT No.: PCT/IB11/55368

§ 371 Date: May 23, 2013

(30) Foreign Application Priority Data
Dec. 1, 2010 (SG) 201008854-0
Dec. 1, 2010 (SG) 201008859-9
Dec. 2, 2010 (SG) 201008890-4
Dec. 2, 2010 (SG) 201008892-0
Dec. 3, 2010 (SG) 201008928-2
Dec. 4, 2010 (SG) 201008961-3
May 17, 2011 (SG) 201103530-0

(51) Int. Cl. F16M 11/22; G06K 7/10

(52) U.S. Cl. CPC F16M 11/22; G06K 7/10009
USPC 340/10.1; 248/188.8

(57) ABSTRACT

The application provides an attachable support for attachment to a bottom surface of an equipment. The attachable support, which has a height of at least 1 cm, comprises a casing for supporting a weight of the equipment. The casing comprises an attachment portion for securing the attachable support to the bottom surface of the equipment, a first casing portion, and a second casing portion. The first casing portion and the second casing portion form a compartment of the casing, which is located below the attachment portion. The compartment houses an electric circuit and a communication means which is connected to the electric circuit. The electric circuit provides a cooperation with the equipment.

The present application relates to a device support for a system unit which is capable to communicate via electric signals.

In the prior art, RFID tags are known which can be attached to an object and are capable to communicate with an RFID reader. For example, US 2007/0222610 discloses an RFID (Radio Frequency Identification) tag for preventing unauthorized access.

It is an object of the present application to provide an improved supporting foot for a system unit, which provides a communication means.

To this end, the application discloses an attachable support, also referred to as foot, base, or pedestal, for attachment to a bottom surface of the equipment.

The attachable support comprises a casing, which is provided, among others, for supporting a weight of the equipment, for creating a distance between a bottom surface of the equipment and for providing sufficient space for electrical devices within the attachable support. The distance that is provided by the attachable support can be used for cleaning, for moving the device around, for protecting the bottom surface of the device from direct contact, for adjusting a height or inclination of the equipment and for providing sufficient space for electric devices of the attachable support. For example, accessing a RFID antenna in the attachable support with a reader is possible from a wider range of angles when the attachable base provides sufficient distance between the bottom surface of the equipment and a base surface.

The casing comprises an attachment portion for securing the attachable support to the bottom surface of the equipment. According to the application, the attachable support may comprise one of various types of attachment or fixture portion to fix it to the equipment. Advantageously, the attachment is permanent such that it does not come off during the lifetime of the equipment under usual wear and tear conditions.

The casing comprises a first casing portion and a second casing portion, which form a compartment of the casing between them. In an orientation of the attachable support in which the attachable support is attached to the bottom surface of the equipment, the compartment is located below the attachment portion. Thereby, the compartment is protected from below and a smooth surface with a pleasant appearance can be provided at the bottom of the attachable support.

The two portions may form one piece that permanently encloses the circuit. The two casing portions may also be separate parts, which are attached to one another. The casing portions may be attached to one another in a detachable way, for example in order to service the circuit or for upgrading the circuit with a new memory component. The casing portion may be connected via a bayonet lock, a snap lock, with engaging hooks, for example.

There are various advantages of providing a support under the bottom surface. A height or inclination of the equipment can be adjusted to provide space for air circulation or a better position of the equipment, the equipment can be moved on the feet rather than on the bottom surface etc. To provide good air circulation and accessibility, the height of the attachable support is made at least 1 cm high.

According to the application, the compartment houses an electric circuit and a communication means. The communication means is connected to the electric circuit and provides a cooperation between the attachable support and the equipment via the communication means. The cooperation can be functional, for example by exchange of data between the attachable support and the equipment via antennas or a cable, or it can also be passive, for example by providing an identity information of the equipment, wherein the identity information can be retrieved by interacting with the electric circuit via the communication means, for example by using a RFID reader device. The communication means may be provided by an antenna or also by an output jack for data transfer between the equipment and the attachable support.

An electrical signal that triggers the cooperation can be provided by an electromagnetic wave from a reader, by a signal that is powered by an internal power source, such as a battery or which is powered by an external power source, such as a notebook which is connected to the foot. It is also possible to run the electric circuit as a radio beacon, which transmits beacon signals. To that end, the circuit may comprise a clock. The circuit and the clock are then configured to send an identification signal in pre-determined time intervals. Thereby, the equipment can be easily located.

For easy access to the electric circuit, the second casing portion may be provided below the first casing portion. Then, the electric circuit can be accessed from above by removing the upper first portion.

The attachable support may comprise on or more of various types of attachment portions. The attachment portion may be formed out as an integral part on the first casing portion of the casing. The attachment portion may simply provided by a surface on the first casing portion or it may also comprise attachment means.

For a releasable and durable attachment, the attachable support may comprise a threaded portion for attachment to a corresponding thread of the equipment or of a part that is fixed to a bottom surface of the equipment. The attachable support may also comprise a snap-on part that fits onto a corresponding snap-on part on the equipment, which can be an integral portion of the bottom surface of the equipment or fixed to the bottom surface of the equipment. Alternatively or in addition, the attachable support according may comprise a magnet for attachment to a bottom surface of the equipment. The attachable portion may also be provided as a separate part that is connected to the first portion of the casing.

The first casing portion may be connected to the second portion in a permanent way so as to provide a good protection for the electric circuit. For example, the first casing portion may welded to the second casing portion by plastic welding or it may be glued to the second casing portion. If it is desired that the electric circuit is easily accessible, the first casing portion may be connected to the second casing portion detachably by using a snap fit such as a bayonet lock, a snap lock, or others.

Furthermore, the electric circuit may comprise an RFID tag unit, which is enclosed by the casing and an antenna that is connected to the RFID tag unit. Thereby, an RFID function can be integrated in a part that is durably attached to the equipment with little or no modifications to the equipment itself. The casing may be made of plastic or another non-conducting material so as to not interfere with the RFID antenna. The casing of the attachable support also keeps the RFID antenna at a distance to metallic surfaces of the equipment that could interfere with the function of the antenna.

The casing of the attachable support can take various forms. A bottom surface of the casing may be curve shaped, especially as convex surface such as a half-sphere. The bottom surface may be provided at the second casing portion or also at a separate part which is attached to the second casing portion. An inclination of the device can be adjusted by putting the attachable support at a pre-determined location of the bottom surface of the equipment. The attachable support then rests on a contact point of the convex surface, which depends on the position of the attachable support. A convex or half-spherical shape has a small contact area that makes it easy to move the equipment around on a table and to adjust an inclination of the equipment, especially if the casing of the attachable support has a smooth surface.

The casing may also be shaped as a cylinder. The cylinder provides a firm stand and distributes the load on the bottom surface of the cylinder. The casing may also be shaped as an elongated box. In order to provide a firm stand, the elongated box may be provided with a length of at least 10 cm. In general, it is advantageous to provide a length of at least half the width of the bottom surface of the equipment. Moreover, the elongated box may be provided with sockets for the connection of various electrical devices or plugs. The sockets are connected to the electric circuit.

A height of the elongated strip may be made comparable to a width of the elongated box, the width being perpendicular to a longitudinal axis of the box. For example, the height may differ from the width within a factor of ten. The elongated box may in addition comprise curve shaped or semi-spherical parts on the bottom of a casing of the elongated box. The elongated box can be made of plastic or rubber for example. When the attachment is used as a support for a printer, the rubber can dampen vibrations.

According to the application, a cooperation between the attachable support and the equipment can be provided in various ways. For example, for an equipment that is capable of communication, such as an electronic device, the attachable support may comprise an output jack that is connected to the electric circuit. The electric circuit is configured to exchange information between the attachable support and the equipment via the output jack.

In another embodiment, cooperation is provided via RFID technology. The electric circuit of the attachable support comprises an RFID tag unit. The RFID tag unit is located in the compartment. Furthermore, the attachable support comprises an antenna, which is connected to the RFID tag unit. The compartment of the attachable support comprises a memory that is connected to the RFID tag unit, wherein a cooperation with the equipment is provided by an identity information of the equipment that is stored in the memory.

The memory may comprise an erasable RAM, for example a flash memory, which comprises the identification information of the equipment, such as a MAC number, servicing information, an operating manual or other product related data such as servicing times and performed service operations, equipment price, equipment certificates and security class, input/output specification of the equipment as well as other equipment specifications. In particular, the erasable RAM may be provided by a flash memory. The erasable RAM can also be used independently or in addition to the RFID functionality to provide a backup-facility for data. If, for example, data in a memory of the equipment is destroyed, the backup data in the attachable foot can still be used.

The RFID functionality provides an improved supporting foot, also referred to as “RFID foot” with a casing or housing and a wireless identification device, wherein the housing encloses or surrounds the wireless identification device. The wireless identification device includes an electric circuit, such as an integrated circuit, and an antenna.

The system unit refers to a piece of equipment with a bottom for resting above a platform. Examples of the equipment include computer related equipment such as a laptop with a printer, office equipment such as a desktop telephone and projectors, industrial equipment such as bar code printer, retail equipment such as a cash register and a display stand, sports equipment such as a golf bag and a pool table, kitchen equipment such as a microwave oven and a wine refrigerator, and house equipment such as a cabinet, a sofa, and lamps.

Preferentially, the fixture or attachment of the foot according to the application is a permanent fixture in that it does not come off during the lifetime of the equipment. Thereby, the equipment can always be tracked when the attachable support is provided with an RFID function. According to the application, a permanent fixture can be achieved with a screw, a snap lock, a snap fit, or glue, for example. The attachment may also involve a modification of a bottom surface of the equipment.

In use, the housing is attached to a bottom surface of the system unit such that the housing acts a permanent fixture of the system unit, wherein the permanent fixture cannot be easily removed. The attachment holds the housing to the system unit during the usual usage of the system unit. This attachment is often provided during production or during assembly of the system unit.

When the system unit rests on a base platform, the housing supports the weight of the system unit and protects the bottom surface of the system unit by separating the system unit from the base platform. The separating also provides an air gap between the system unit and the base platform such the air gap allows dissipation of heat from the system unit to the surrounding. In addition, the air gap provides space for fingers of a user to lift the system unit in an easy manner.

The wireless identification device exchanges electromagnetic signals with an interrogator. The interrogator is known as a reader. In particular, the antenna of the wireless identification device is used for receiving electromagnetic wave signals from an antenna of the reader. The wireless identification device may use energy induced by the received electromagnetic waves for its operation. This is also referred to as a passive operation mode. The received electromagnetic waves may also activate the wireless identification device such that the wireless identification device changes from a sleep or low power mode to an operational mode. This is also referred to as a semi-passive operation mode.

The integrated circuit demodulates the signals in which the demodulation extracts data from the signals. The integrated circuit later processes the extracted data and it afterward provides identifier data with possibly other data in accordance with the received data. The identifier data is associated or is linked earlier with a system unit, which is attached to the supporting foot.

The integrated circuit afterwards modulates the identifier data, wherein the modulation allows the identifier data to be transmitted effectively. Thereafter, the antenna of the wireless identification device transmits signals that carry the identifier data to the antenna of the reader. In this manner, the reader reads or obtains the system unit identifier data from the supporting foot.

Advantageously, the RFID foot is designed as a permanent fixture of the system unit throughout its product life span. Thereby, the system unit identifier data can be obtained from the system unit at any point of its product life. The system unit does not need to be powered in order for the data to be retrieved as the integrated circuit of the supporting foot has its own power source or it obtains power from the reader. Put differently, the supporting unit provides a self-sufficient system that provides the system unit identifier data. No change to the operating system of the system unit is then required. This is a benefit, such for the system unit, such a laptop, which are not easy to modify.

Often, the housing is attached to a pre-determined area of the system unit such that the supporting foot is easily located or is easily seen.

The wireless identification device can be implemented in a passive form, which requires energy from an external source, or in an active form, which includes an internal energy source.

The supporting foot can be used to track movement of the system unit, which also provides indication of movement of a user of the system unit, who carries the system unit. In one example, a supporting foot allows movement of a laptop as well as its user to be monitored, wherein it is assumed the user carries the laptop for meetings and when the user travels.

If the system unit is already equipped with an RFID foot at the point of sale, it can be used to prevent shoplifting. Moreover, the RFID foot according to the application can also be used for keeping track of the device from the production facility to the sales point. Furthermore, the RFID capability may also be used for contactless payment, either to pay for the system unit to which the foot is attached or for payment of other services, which are supplied, to the system unit to which the RFID foot is attached.

The attachable support may comprise an external antenna for better reception. Alternatively or in addition, the attachable support may comprise an internal antenna, which is enclosed and protected by the compartment. For example, the internal antenna may be provided by one or more coils that are provided at a surface of the compartment. The attachable support may furthermore comprise a connection for an external antenna. An external antenna may also be provided as a metal part, which is provided or formed out on the casing, for example between the first casing part and the second casing part. By providing an external antenna, attenuation by the casing is avoided. On the other hand, the walls of the casing can be made thin in order to reduce attenuation.

The attachable support may comprise one or more control lamps or a loudspeaker, which are connected to the circuit. The casing may comprise openings for the one or more control lamps or for the loudspeaker. For example, the control lamps or the loudspeaker may be used to indicate a state of charge of a battery. If the battery charge is low, the electric circuit generates a visible or audible signal. The battery may then be exchanged or a USB or other jack may be provided in the casing of the attachable support to allow recharging of the battery. The loudspeaker can be used to transmit information about the equipment, it can alert of the presence of the equipment, or it can also be used as a theft-warning device.

Further devices may be connected to the circuit and included in the casing of the attachable device. The further devices may also be provided in pockets of the attachable support. By providing pockets for the insertion of electronic devices, wherein the pockets are electrically connected to the circuit, the functionality of the attachable support can be made configurable.

The devices may comprise optical devices such as a camera, a laser pointer or a mini projector, acoustical devices such as a microphone, connection jacks such as USB or Firewire connectors, data input/output connections such as electrical, optical or infrared output/input connectors. Furthermore, the casing of the attachable support may comprise memory and a location function, such as GPS, which may be provided by the circuit. The location function can be used in conjunction with the RFID function to provide a location of the equipment. By using an equipment foot to accommodate devices such as the RFID tag unit, the devices can be tucked away under the equipment instead of affecting the appearance and functionality of smooth equipment side surfaces. Moreover, the devices, such as the RFID tag, can be hidden by providing them inside the equipment foot

Furthermore, sensors may be connected to the circuit of the attachable support such as a movement sensor, a gas or a trace particle sensor a radiation sensor, a temperature sensor, a biometric sensor. The sensor can be used to alert of undesired conditions, for example it can be used to alert mine workers of trace gases.

The attachable support may also provide a card reader slot for providing user identification, for financial transactions or for other purposes. The user identification can be used as an authorization to change memory content of a memory that is included within the attachable support or to activate certain functions.

In order to provide the circuit with power, the antenna or any attached devices with electric power the compartment may house an electrical power supply, such as a battery, which is connected to the circuit. While an RFID function may harness the power of a received signal, other functions will often require a power supply. Alternatively or in addition, an input jack for an external power supply, which is connected to the electric circuit, may be provided. Thereby, the circuit can be supplied by a power supply of the equipment or any other external power supply.

Furthermore, the application discloses an equipment, also known as system unit, which comprises at least one of the abovementioned attachable supports, wherein the one or more attachable supports are fixed to the bottom of the equipment. The equipment may moreover be configured to exchange data with the attachable support via a wireless radio connection or via a cable.

The application also discloses a communication system, which comprises the equipment that is equipped with at least one of the aforementioned attachable supports with a RFID tag, and a reader. The reader is configured to communicate with the RFID tag unit via a first wireless communication protocol, such as a RFID proprietary protocol a Bluetooth protocol or other, and the reader is configured to communicate with a computing system such as a computer or also a computing cloud via a second wireless communication protocol such as WiFi, Wimax, WLAN, Bluetooth or others.

Instead of providing a location functionality within the attachable foot or support, the location functionality can also be provided within the reader of the communication system. Instead of using GPS or other satellite based systems, the location functionality may use transmitters which are used as reference points, such as pseudo GPS. These may be purposely installed transmitters or also cell phone transmitters that are configured as location servers.

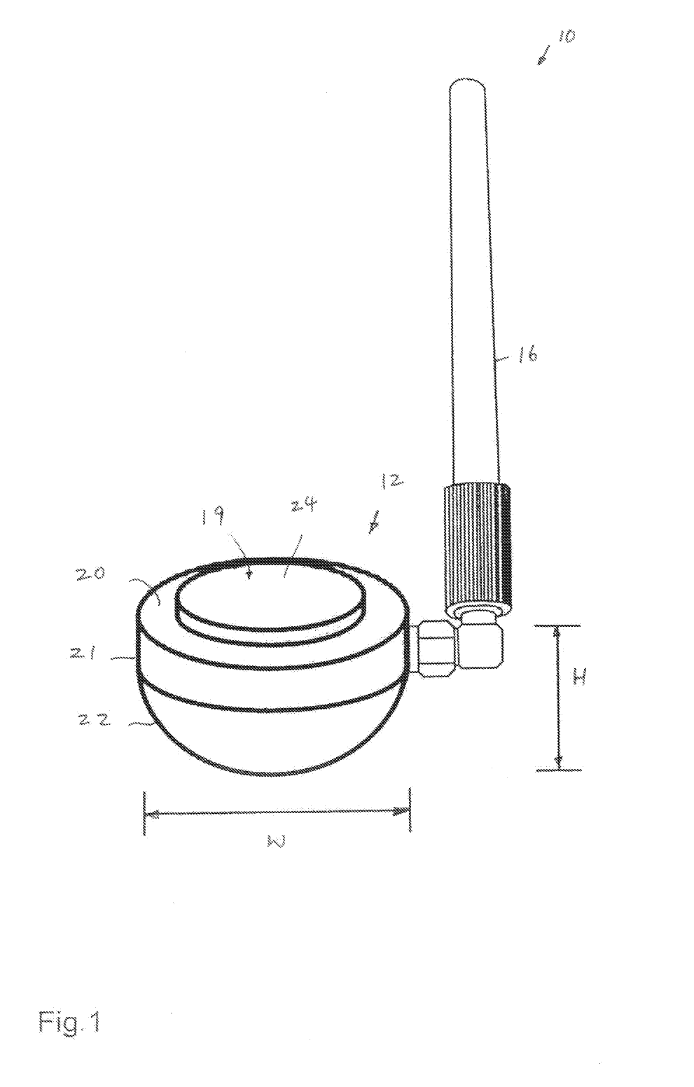

FIG. 1 illustrates a front view of a Radio Frequency Identification (RFID) foot,

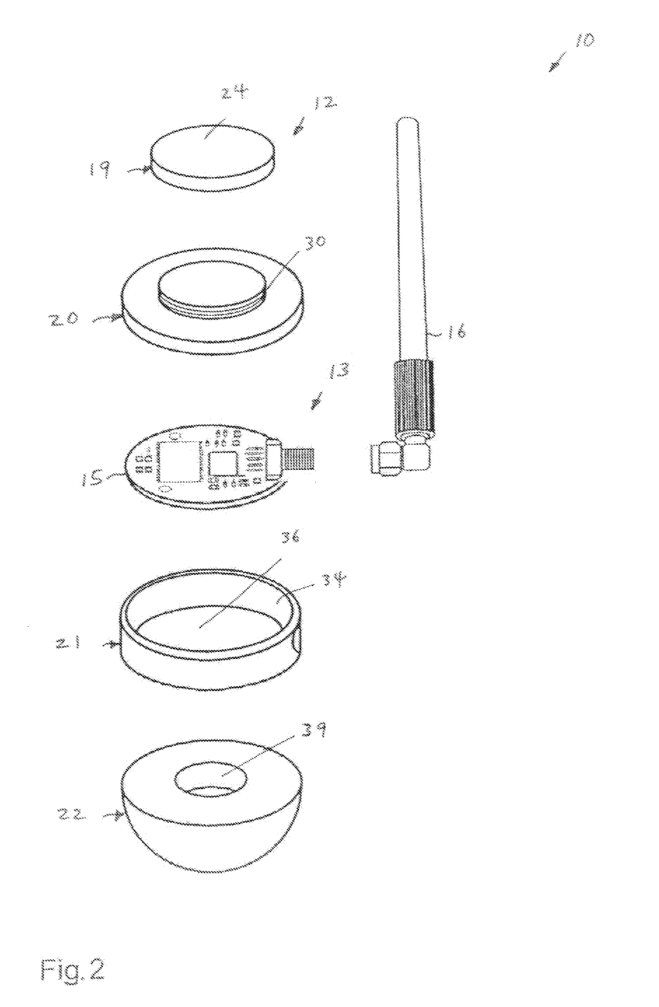

FIG. 2 illustrates an exploded isometric view of the RFID foot of FIG. 1,

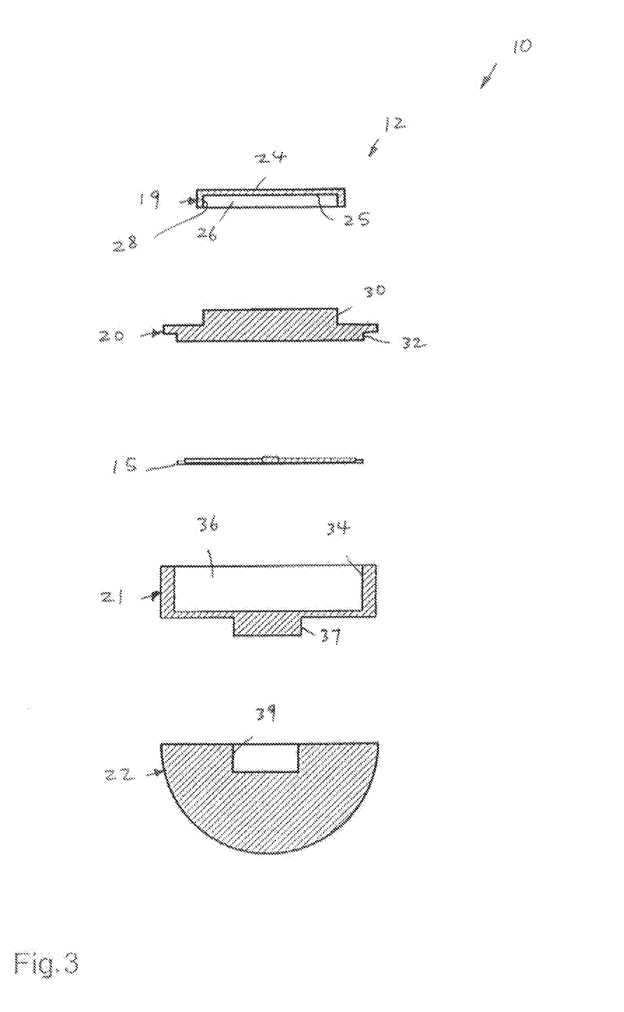

FIG. 3 illustrates an exploded sectional view of the RFID foot of FIG. 1,

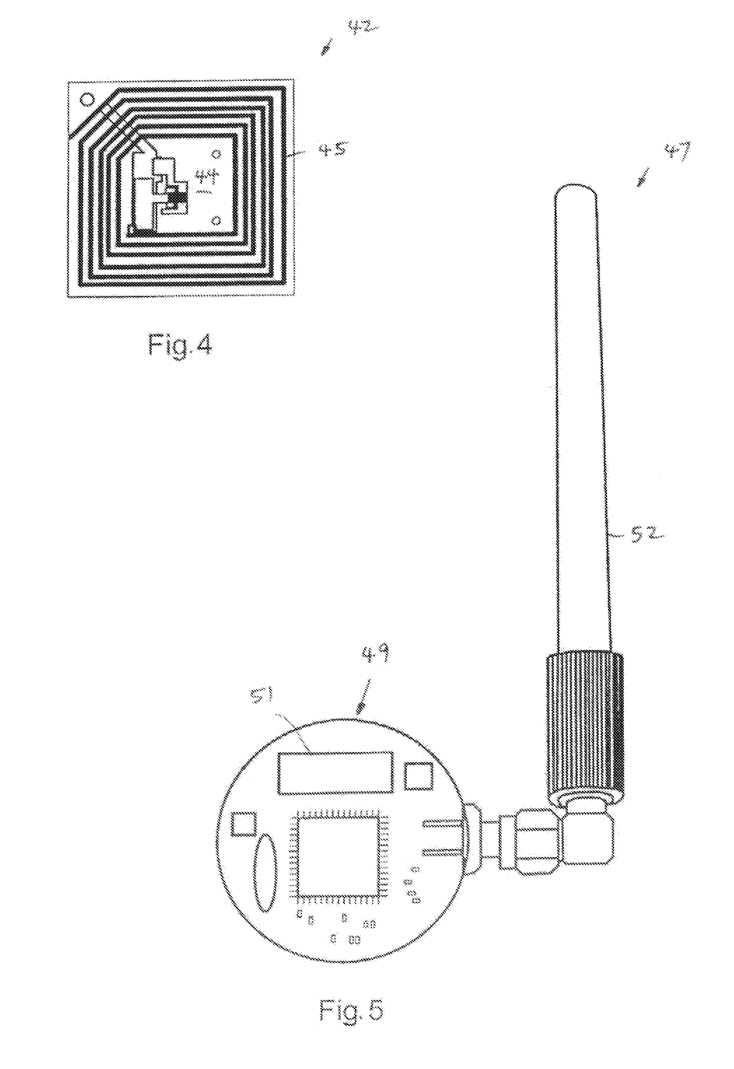

FIG. 4 illustrates a passive RFID device for the RFID foot of FIG. 1,

FIG. 5 illustrates an active RFID module with an antenna for the RFID of FIG. 1,

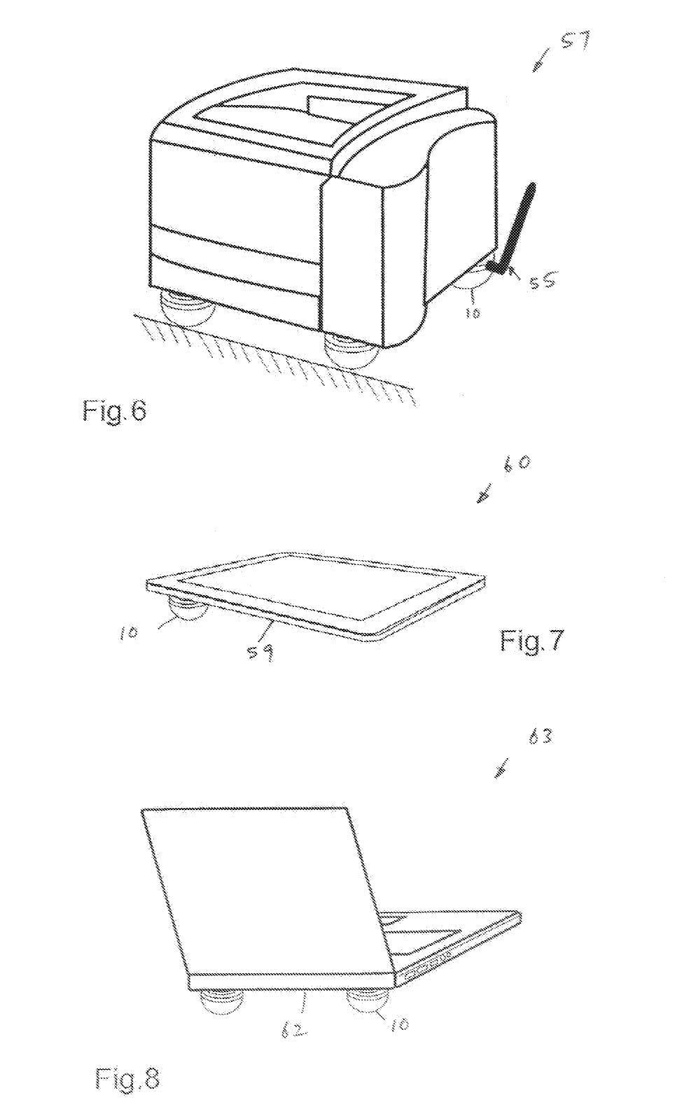

FIG. 6 illustrates the WiFi RFID foot of FIG. 1 being attached under a printer,

FIG. 7 illustrates the RFID foot of FIG. 1 being attached under a computer tablet,

FIG. 8 illustrates the RFID foot of FIG. 1 being attached under a laptop,

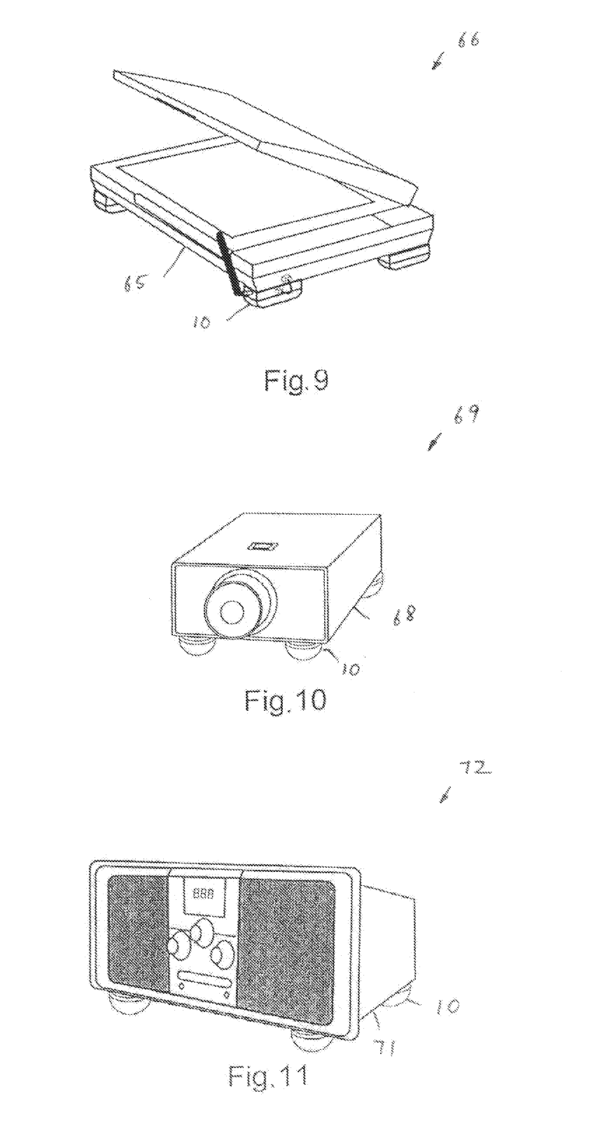

FIG. 9 illustrates the RFID foot of FIG. 1 being attached under a scanner,

FIG. 10 illustrates the RFID foot of FIG. 1 being attached under a projector,

FIG. 11 illustrates the RFID foot of FIG. 1 being attached under a Hi-Fi sound system,

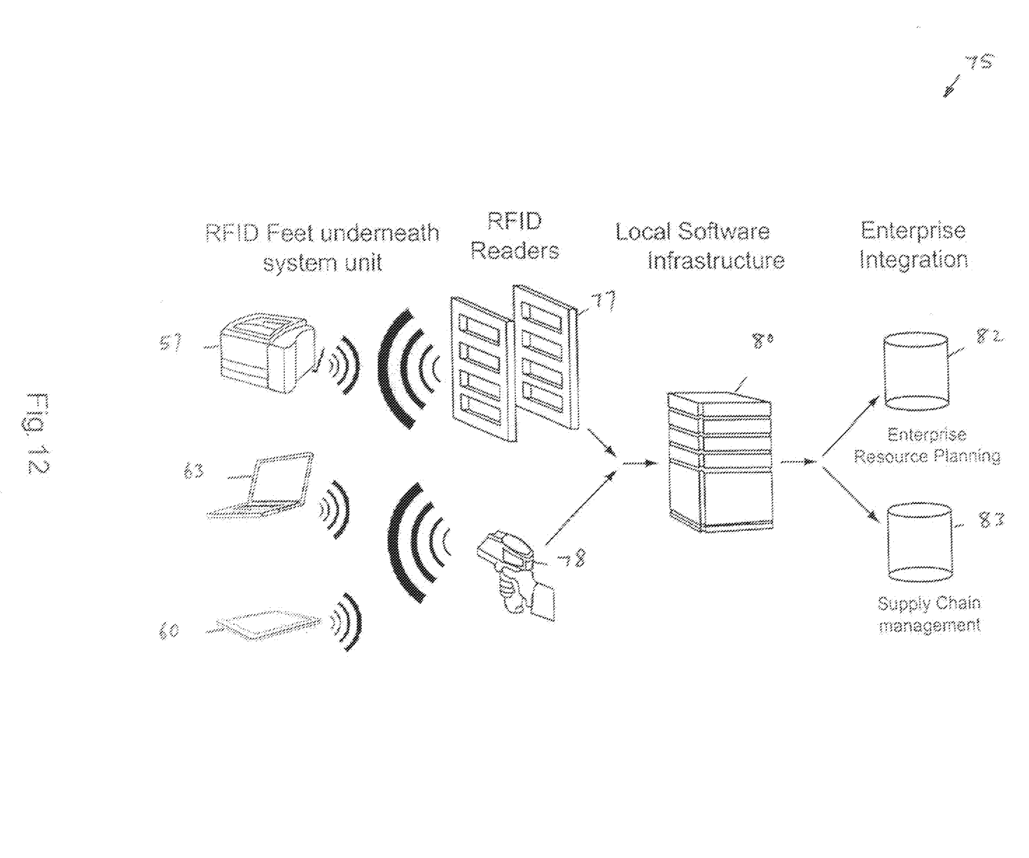

FIG. 12 illustrates a RFID data interface diagram for the RFID foot of FIG. 1,

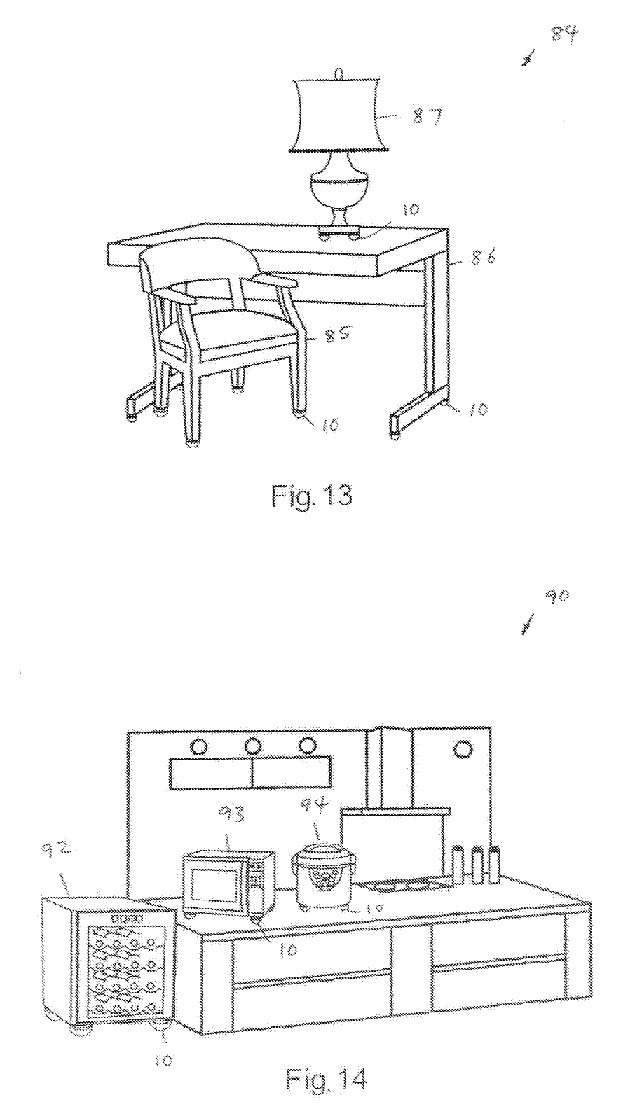

FIG. 13 illustrates a house with equipment that includes the RFID foot of FIG. 1,

FIG. 14 illustrates a kitchen with equipment that includes the RFID foot of FIG. 1, and

FIG. 15 illustrates an office with equipment that includes the RFID foot of FIG. 1,

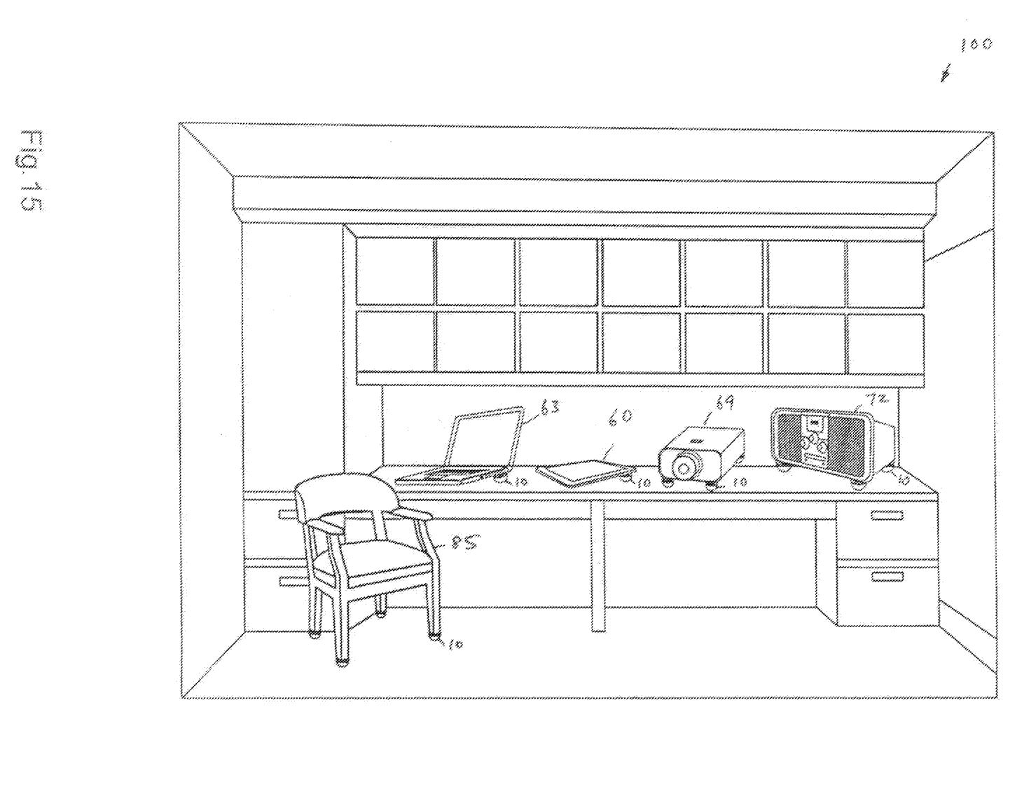

FIG. 16 illustrates a first RFID foot attachment,

FIG. 17 illustrates a second RFID foot attachment,

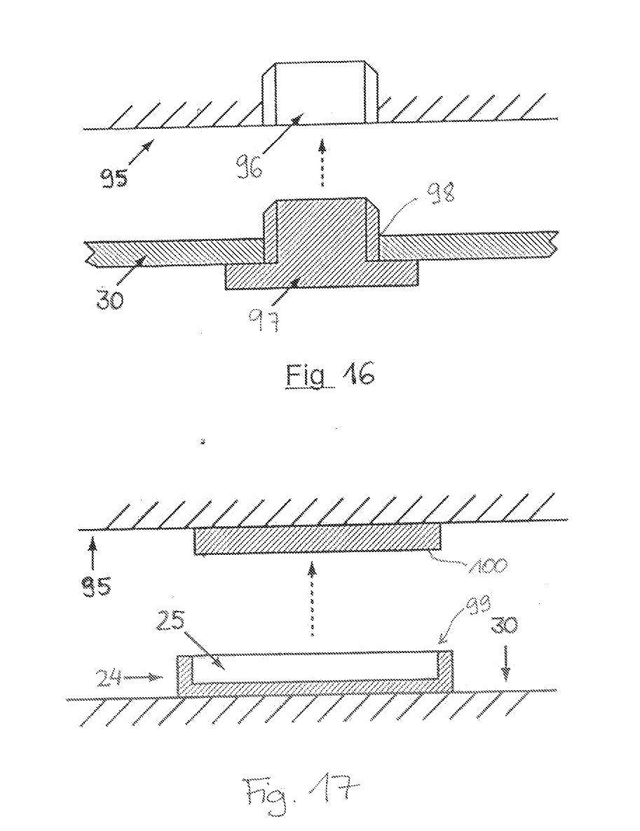

FIG. 18 illustrates a third RFID foot attachment,

FIG. 19 illustrates a notebook with an elongated RFID foot,

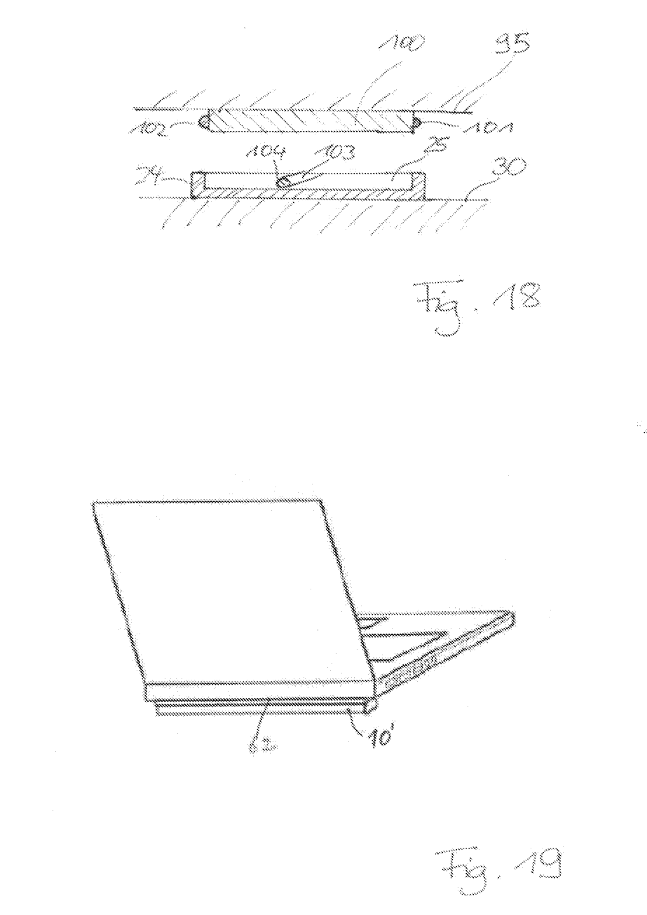

FIG. 20 illustrates an exploded view of a notebook with a second elongated RFID foot,

FIG. 21 illustrates a perspective view of the notebook with the second elongated RFID foot,

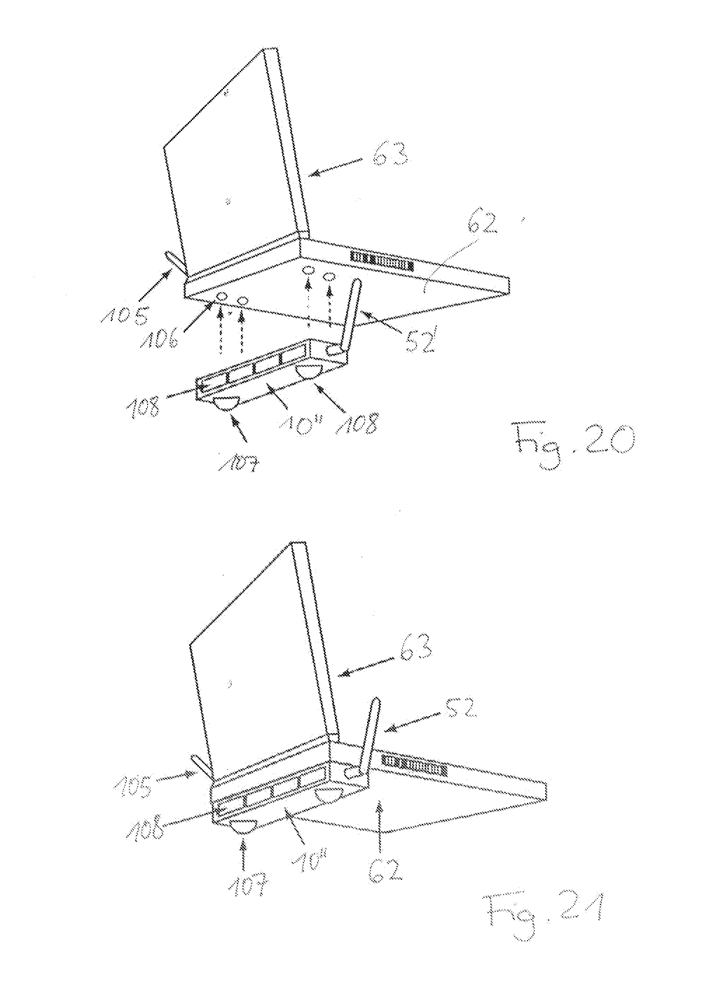

FIG. 22 illustrates a schematic diagram of a communication system, which comprises equipment with a RFID foot according to the application,

FIG. 23 illustrates an RFID foot which is read by a reader, and

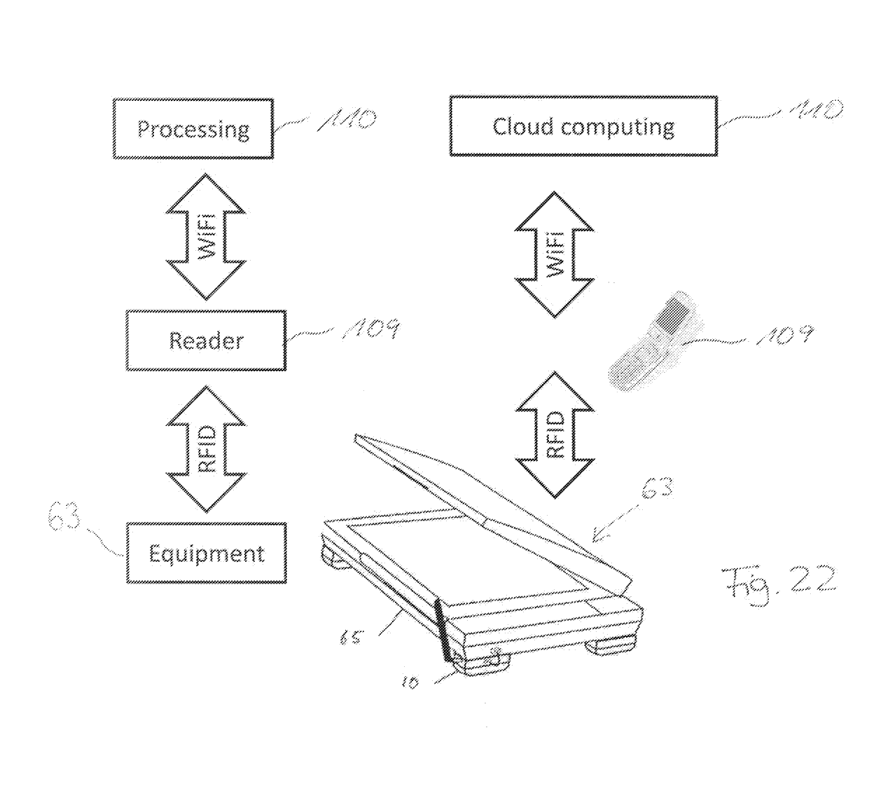

FIG. 24 illustrates an RFID foot with a connection to a power outlet.

In the following description, details are provided to describe embodiments of the application. It shall be apparent to one skilled in the art, however, that the embodiments may be practiced without such details.

Some parts of the embodiments, which are shown in the Figs. below, have similar parts. The similar parts may have the same names or the similar part numbers. The description of such similar parts also applies by reference to other similar parts, where appropriate, thereby reducing repetition of text without limiting the disclosure.

FIGS. 1, 2, and 3 shows different views of a Radio Frequency Identification (RFID) foot 10.

As seen in FIGS. 2 and 3, the RFID foot 10 has a housing 12 that encloses a RFID device 13.

The RFID device 13 includes an integrated circuit 15 and an antenna 16 whereas the housing 12 has a shape of a hemisphere and it includes a top cap 19, a cover 20, a cup 21, and a bottom base 22.

Referring to the housing 12, the top cap 19 has a top surface 24 and a bottom surface 25 in which the bottom surface 25 includes a recess 26. The recess 26 has a sidewall 28 with internal threads for screwing onto external threads of a top part 30 of the cover 20. The cover 20 has a bottom surface 32 that is connected to a top rim 34 of a recess 36 of the cup 21 by a snap or pressure fit, wherein the top recess 36 receives or holds the integrated circuit 15. The connection between the cover 20 and the cup 21 encloses the integrated circuit 15. A bottom part 37 of the cup 21 is connected to a top recess 39 of the bottom base 22 by a snap or pressure fit.

Parts of the housing 12 comprises plastic, such as Acrylonitrile Butadiene Styrene (ABS), although other types of material including rubber with ABS and metal, or a combination of rubber, ABS and metal is also possible.

The RFID foot 10 is adapted to an attachment to a bottom surface of a system unit. According to the application, different types of attachment can be provided for the RFID foot 10, such as a screw connection, a glue, a hook and loop fastener. The shape, such as height H and width W, and colour of the RFID foot 10 is arranged to match with the system unit such that the RFID foot 10 and the system unit appear as one integral device.

In use, the RFID foot 10 is used for attaching to the system unit The attachment is done such that the RFID foot 10 is a permanent part of the system unit in that the RFID foot 10 cannot be easily removed from the system unit. The RFID foot 10 does not separate or drop off from the system unit during the usual usage of the system unit. In short, the RFID foot 10 moves or travels together with the system unit.

The housing 12 of the RFID foot 10 provides support to the system unit and it acts as an end-terminal point contact between the system unit and a base platform, wherein the housing 12 supports the weight of the system unit.

In a general sense, the housing 12 can be used with every system unit that requires a supporting structure.

The RFID foot 10 is different from other Radio-Frequency Identification (RFID) device in that its housing is adapted for supporting the system unit. In contrast, a Radio-Frequency Identification (RFID) tag often can be removed easily and is not designed to support the weight of the equipment or to withstand the wear and tear when the equipment is moved around. Advantageously, the RFID foot is high enough that radio waves from a reader can reach the RFID antenna of the RFID foot even if the reader is not directly pointed at the RFID foot. The RFID antenna of the RFID foot is oriented and arranged in the RFID foot in such a way that radio waves which travel at an angle to a bottom surface of the RFID foot or of the equipment generate can excite the RFID antenna. This is different from a standard RFID tag which does not function well if the surface opposite to the attachment surface is covered.

Furthermore, a foot according to the application can provide a circulation of air under the equipment. If the foot is placed at the rear section of a notebook bottom surface, a wedge shaped gap is formed between the bottom surface of the notebook and the surface on which the notebook rests. This can provide a more ergonomic positioning of the keyboard keys, for example.

The housing 12 also covers the RFID device 13 such that the RFID device 13 is not seen. In other words, the housing 12 conceals the RFID device 13 or conceals the identification function of the RFID foot 10. This hinders an unauthorized person from locating the RFID foot 10 in order to remove the RFID foot 10 from the system unit. This also allows the RFID foot 10 to prevent theft of the system unit, wherein a reader can detect an unauthorized movement of the system unit.

The housing 12 also provides a protective enclosure for the RFID device 13.

In particular, the top surface 24 of the top cap 19 is intended for attaching to a bottom surface of a system unit. The attachment can be achieved by using a screw fastener, a bolt fastener, or a double-sided permanent adhesive tape.

The bottom base 22 of the housing 12 is intended for contacting a supporting surface. In one implementation, the bottom base 22 has a coating layer that allows the bottom base 22 together with the system unit to slide easily on the supporting surface. The bottom base 22 can also include a roller, which is similar to a roller of a luggage, for easily movement on the supporting surface. In another implementation, the bottom base 22 has a high friction layer of coat to prevent the bottom base 22 together with the system unit from moving. This is especially useful for allowing the system unit be placed on a high and tight shelving.

The RFID device 13 acts as a transponder or a transceiver that communicates with an interrogator using radio frequency signals or electromagnetic wave signals. The interrogator is known as a reader.

For easy communication with the reader, the RFID foot 10 with the RFID device 12 is often positioned an area of the bottom surface of the system unit that allows easy communication with the reader.

Since the RFID foot 10 is attached with the system unit, the reader interrogating the RFID 10 can track and monitor the system unit. As an example, the system unit includes a computer laptop. The RFID foot 10 is attached to the laptop, which is assigned to an employee. The reader can track the laptop via tracking the RFID foot 10. Furthermore, the employee carrying the laptop can also be tracked.

Different implementations of the RFID device 13 are possible. The RFID device 13 can include a passive RFID module and an active RFID module.

FIG. 4 shows a passive RFID module 42 for the RFID foot 10 of FIG. 1. The passive RFID module 42 includes an integrated circuit 44 and an antenna 45. The integrated circuit 44 includes identifier data.

The passive RFID module 44 does not have an internal power source or battery and it receives energy from an external source.

In operation, the RFID foot 10 with the passive RFID module 44 is attached securely to a system unit and the identifier data is associated or linked to the system unit.

The antenna 45 is used for receiving electromagnetic wave signals from an antenna of a reader, wherein the received electromagnetic wave signals induce electrical current in the antenna 45. The induced electrical current provides electrical power or energy to the integrated circuit 44. The energized integrated circuit 44 may demodulate the received signals in which the demodulation extracts data from the said received signals. The integrated circuit 44 then transmits the identifier data to the reader. In particular, the integrated circuit 44 modulates the identifier data into electromagnetic waves that carries the identifier data, wherein the modulation allows efficient transmission of the data to the reader.

The passive RFID module 44 and the reader can have an operating range of about a fraction of an inch to about 30 feet depending on electromagnetic wave frequency, antenna size, and electrical power of the reader electromagnetic wave.

The electromagnetic wave may operate in low frequency, in high frequency, in ultra-high frequency, or in microwave frequency. In one example, the passive RFID module 44 is operating in below about 100 MHz (megahertz) frequencies, such a range between about 125 kHz (kilohertz) and about 134.2 kHz and in about 13.56 MHz. In another example, the passive RFID module 44 operates at about 900 MHz and at about 2.45 GHz (gigahertz).

In another example, this passive RFID module 44 has a dipole antenna with ⅛ wavelength construction and an operating distance of more than 3 meters.

FIG. 5 shows an active RFID module 47 for the RFID foot 10 of FIG. 1. The active RFID module 47 includes an integrated circuit 49 with a battery 51 and with identifier data and an antenna 52.

In use, the RFID foot 10 with the active RFID module 47 is connected securely to a system unit while the identifier data is associated or is linked to the said system unit.

The antenna 52 is used for receiving an electromagnetic wave signal from a reader. The battery 51 acts a power supply for providing energy to electric circuitry of the integrated circuit 49. It can be either of the rechargeable or the non-rechargeable type. The energized integrated circuit 49 then modulates the identifier data into electromagnetic waves for broadcasting to the reader by the antenna 52.

In order to provide a longer battery lifetime, the RFID foot may be provided with an energy generator that harnesses solar energy, such as a solar cell or for harnessing motion energy that stems from movement of the system unit. The energy generator may comprise silicon solar cells but also, organic photovoltaic cells such as Grätzel cells

The active RFID module 47 can also include an interface with sensors for collecting data and for reporting the sensor data together along with the identifier data.

Because the active RFID module 47 has the battery 51 providing on-board power source, the active RFID module 47 does not need to be in close proximity to the reader for the broadcast to be successful. It can have a transmit range of about 35 feet to about 1,000 feet and even further. The active RFID module 47 of ten operates at microwave frequencies of about 2.4 GHz. When the active RFID module 47 operates in low and in high frequencies, the transmit range is less than about 3 feet.

To conserve energy, the active RFID module 47 can incorporate a sleep mode and a wake-up mode. In this, the active RFID module 47 acts as a semi-active RFID module or a semi-passive RFID module. In the sleep mode, the active RFID module 47 consumes a low amount of power. Here, the active RFID module 47 behaves like a passive RFID module. When it receives a wake-up signal from a reader, it changes to the wake-up mode, wherein the integrated circuit 49 is energised for transmitting data. Here, the active RFID module 47 behaves like an active RFID module.

The RFID foot 10 can use different protocols for communicating with the reader.

The protocols can be defined by International Organization for Standardization (ISO), by International Electro-technical Com mission (IEC), by ASTM International, by DASH7 Alliance, and by EPC global.

In one implementation, the RFID foot 10 operates using the peer to-peer RuBee protocol, which complies with IEEE 1902.1 specification. The RuBee protocol includes a packet based wireless protocol that operates with signal at 131 kHz in the near field, which that means 99.999% of its operating signal is magnetic. It can operate at other frequencies, such as about 450 kHz, although it operates optimally at about 131 kHz. The packet based wireless protocol provides a two-way, active wireless communication that uses long wave (LW) magnetic signals to send and to receive short data packets of 128 bytes in a local regional network for providing bidirectional, on-demand, and peer-to-peer communication. The RuBee protocol also uses an IP Address (Internet Protocol Address).

An RFID module that uses RuBee protocol has typically dimensions of about 1 inch by 1 inch by 0.07 inches and it includes a 4-bit CPU, 1 to 5 kB (kilobyte) of SRAM (static random access memory), a clock, and a lithium battery with a life expectancy of five years. It could optionally have sensors, displays, and buttons. The module may hold data in its own memory, instead or in addition to having data stored on a server. Depending on antenna configuration, a Rubee module can function successfully with networks of many thousands of modules, and has an operating range of about 1 meter to about 30 meter or of about 3 to about 100 feet.

In another implementation, the RFID foot 10 operates using the ZigBee protocol that complies with IEEE 802.15.4 standard within a high-level mesh networking protocol star, point-to-point sensor networks reader network. The network is managed by a central node, created by attaching an unmodified ZigBee coordinator to a computer, and is controlled by a personal-computer-based application. Also included in the network are ZigBee-enabled RFID readers. The ZigBee protocol allows devices within the ZigBee network to act as routers or as end-devices. A firmware that resides in microcontrollers of ZigBee modules configures the said devices to act as the routes or act as the end-devices. Hardware for each of these nodes is the same. The ZigBee wireless mesh network comprises a ZigBee coordinator, ZigBee routers, and ZigBee end-devices.

In the following Figures the RFID foot is shown with external antenna in FIGS. 6, 9 and 20 to 22 and with an internal antenna in the other Figures. However, the embodiments are not limited to either an external or an internal antenna.

FIG. 6 shows the RFID foot 10 of FIG. 1 with a WiFi device 55 being attached underneath a printer 57, which acts a system unit. The WiFi device 55 is electrically and is communicatively connected to the integrated circuit 15 of the RFID foot 10. The RFID foot 10 also comprises a battery.

During assembly of the printer, the RFID foot 10 is attached to the printer 57. An identifier data of the integrated circuit 13 of the RFID foot 10 is later associated with the printer 57.

The battery provides energy to the WiFi device 55 and to the integrated circuit 15 such that the WiFi device 55 allows the RFID device to communicate with wireless access points of a wireless local area network.

The wireless local area network includes computers, wherein the computers are able to track the RFID foot 10 together with the printer 57, which is associated with the RFID foot 10, via the WiFi device 55.

Since the RFID foot 10 is intended to remain with the printer 57 through the entire product life of the printer 57, a manufacturer as well as an owner of the printer 57 is able to manage inventory control of the printer 57.

The integrated circuit 15 of the RFID foot 10 also can be configured to keep the printer 57 within a fix pre-determined distance from a reference point, which is within a designated area. A reader can trigger an alarm when the printer 57 away from the reference point by more than the fix pre-determined distance.

The wireless access points and the WiFi device 55 comply with IEEE 802.11 specifications.

As described below, the RFID foot 10 of FIG. 1 can be attached to different system units.

The RFID foot 10 can be attached to a bottom surface 59 of a computer tablet 60, as illustrated in FIG. 7. Similarly, the RFID foot 10 can also be attached to a bottom surface 62 of a laptop 63, as illustrated in FIG. 8. The RFID foot 10 can also be attached to a bottom surface 65 of a scanner 66, as illustrated in FIG. 9. The RFID foot 10 can also be attached to a bottom surface 68 of a projector 69, as illustrated in FIG. 10. The RFID foot 10 can also be attached a bottom surface 71 of a Hi-Fi (high fidelity) sound system 72, as illustrated in FIG. 11.

FIG. 12 shows a RFID data interface diagram 75 for the RFID foot 10. The diagram 75 shows system units 57, 63, and 60 communicating with different RFID readers 77 and 78. The readers 77 and 78 are communicatively connected to a local software infrastructure 80, which comprises enterprise resource planning 82 and supply chain management 83.

In general, the RFID foot can be applied on various areas, as shown below.

FIG. 13 shows a room 84 with various system units, namely a chair 85, a table 86, and a lamp 87, all of which are provided each with the RFID foot 10.

FIG. 14 shows a kitchen 90 with different system units, namely a wine refrigerator 92, a microwave oven 93, and a rice cooker 94 being provided with the RFID foot 10.

FIG. 15 shows an office 100 with system units, namely the projector 72, the projector 63, the tablet 60, the laptop 63, and the chair 85 being provided with the RFID foot 10.

FIGS. 16 and 17 show different attachments for a foot according to the application. In FIGS. 16 and 17 the reference number 95 refers to a bottom surface of a system unit such as the bottom surfaces 59, 62, 65, 68, 71.

FIG. 16 shows a screw and thread connection wherein an inner thread 96 is formed out on the bottom surface 95 of the system unit. To fix the foot to the bottom surface 95, a screw 97 is inserted into an opening 98 of the top part 30 of the foot.

FIG. 17 shows a snap on connection. Different from the previous FIGS. 1 to 3, the concave part 99 of the snap connection is provided on the side of the foot. The concave part 99 comprises a rim with an outer surface 24 and an inner surface 25. The convex part 100 of the snap connection comprises a protrusion that fits into the concave part 25. The concave part 99 and the convex part 100 may be fixed to the respective surfaces with a glue, for example. Furthermore, the snap on connection may comprise some sort of snap lock. In addition or alternatively, the snap on connection may be reinforced with magnets, hook and loop surfaces or with a glue.

FIG. 18 shows a snap on connection with a snap lock. The snap lock comprises two half-spherical protrusions 101, 102 at the side of the convex part 100. The concave part comprises two guiding channels with respective cavities. The cavities are half-spherical in shape to match the protrusions 101, 102. In the view of FIG. 18, one guiding channel 103 with a cavity 104 is shown while the other guiding channel, which is at an opposite side, is not shown in FIG. 18.

FIG. 19 shows a laptop in which an elongated RFID foot 10′ is attached to a bottom surface 62 of the laptop. The elongated RFID foot 10′ comprises an internal antenna. Preferentially, the length of the elongated RFID foot 10′ is at least half the width of the bottom surface 62 in order to prevent the system unit from toppling. To provide a balanced support, the elongated RFID foot 10′ may be placed symmetrically with respect to a centre of the bottom surface. The elongated RFID foot 10′ is especially useful for placing an internal antenna inside the RFID foot 10′. In the embodiments of the previous FIGS. 1 to 18, the RFID foot 10 can have an internal antenna as well.

FIGS. 20 and 21 show a further embodiment of an elongated foot 10″ which is attached a bottom surface 62 of a notebook computer 63. The elongated foot 10″ comprises an external antenna 52′. Furthermore, the notebook computer 63 comprises an external antenna 105. The elongated foot 10″ and the notebook computer are configured to communicate via the antennas 52′, 105. One of the antennas 52′, 105 or both of them may be provided as internal antennas as well. The bottom surface 62 comprises four threaded openings 106 for attachment of the elongated foot 10″. The elongated foot 10″ comprises to half-spherical base parts, which are fixed to a bottom surface of the elongated foot 10″. Furthermore, the elongated foot 10″ comprises pockets 108, which comprise a plug connection for taking up electronic devices such as a flash memory, a camera, a mini-projector, a biometric device such as a fingerprint reader, a card reader, or a plug, such as a USB plug for connecting further devices.

FIG. 22 shows a communication arrangement according to the application in which an RFID foot 10 is used to keep track of equipment 63 with the aid of a reader 109. The left side of FIG. 22 shows the general layout while the right side shows a concrete example. In the concrete example of FIG. 22, the equipment is a notebook computer 63 and the reader is a mobile phone with RFID reader capabilities.

The equipment 63 is provided with an RFID foot 10 and is configured to communicate with a reader 63 over a wireless connection. The reader 63 is configured to communicate with a processing system 110 over a wireless network, which is a WiFi connection in the example of FIG. 22. The processing system may be provided by a single computer but also by a computer network or by a computer cloud.

The embodiment of FIG. 22 is not limited to the equipment shown but can be any kind of equipment. For example, it may also be a hospital equipment, equipment on trade shows or other devices that need to be tracked. According to the application, a memory on the RFID foot 10 may comprise an instruction set, for example as firmware or as software application and a clock. The instruction set on the RFID foot 10 uses the clock to trigger the RFID foot to send out messages in regular intervals. In addition, the reader may also comprise a specific instruction set.

In one example, the reader displays a symbol once it has detected the system unit with the RFID foot 10. A user may then trigger the specific set of instructions, for example by pressing the icon. The specific instruction set on the reader 109 then causes data to be transferred to the processing system.

FIG. 23 shows an RFID foot 10 according to the application, which is being read by an RFID reader 78 which emits a signal 106. A RFID antenna 105 is placed within the RFID foot 10 such that a direction of oscillation is essentially perpendicular to a bottom surface 95 of the equipment. FIG. 23 shows an arrangement with a dipole antenna in which the charge carriers oscillate perpendicular to the bottom surface 95 of the equipment in a direction 107. Other antennas may be used as well, especially loop antennas and capacitive antennas.

In case the RFID antenna 105 is provided by a loop antenna, the loop antenna may comprise more than one coil and the coils may be oriented in different directions so as to better catch the signal of the RFID reader 78. According to one embodiment of the application, the antenna coils are placed essentially parallel to a field direction of an incoming signal such that an induced voltage is maximized. One such arrangement may comprise two coils, wherein the planes of the two coils are perpendicular to each other and perpendicular to the plane of the bottom surface 95. To better catch a reader signal 106 coming from diagonally upwards, as shown in FIG. 23, the planes of the coils may also be slightly tilted against the vertical. A coil of the RFID antenna may have a circular, spiral, rectangular or other shape and the coil may be provided as a metallic or conductive trace on a printed circuit board.

FIG. 24 shows a foot 10 with a printed circuit board according to the application, which comprises a jack 108 for inserting a plug connecting the foot 10 to a power outlet via a transformer 109. An cable 110 is provided within the foot which is connected to the printed circuit board, to a loudspeaker 111 and to a fan 112 as well as to a second jack 113. A second plug can be inserted into the jack 113, for example to provide the equipment on which the foot rests with power. Openings are provided in the casing of the foot 10 such that the fan 112 can blow into the opening in between the bottom surface 95 of the equipment and the base surface 30 to improve the circulation below the equipment.

In a further embodiment, a foot according to the application is equipped with a flash memory. The flash memory may comprise a program that provides a security token functionality to the foot. In addition, the flash memory may comprise data, which is related to the system unit to which the foot is attached such as service intervals, part lists, service instructions, instruction manuals, purchase data etc. The data may be specially encrypted. If the foot is used in combination with a RFID capability, the decryption capability may be provided on the RFID reader.

The flash memory drive is used like a hard drive. Rewritable data is stored on an Electrically Erasable Read-Only Memory, which is erased in large block. Different from a USB stick, the flash memory in the foot is not easily lost as the foot sticks to the system unit.

In alternative embodiments, a ferroelectric RAM (FeRAM), a magneto-resistive RAM (MRAM), programmable metallization cells (PMCs), phase change memory (PCM) or other erasable RAM types may be used in place of the flash memory.

According to a further embodiment, a foot according to the application is equipped with a wireless USB (WUSB) device. It is then also known as WUSB foot. Wireless USB employs a wireless technology called Ultra-wideband (UWB) which is designed to operate in the frequency range of 3.1 to 10.6 GHz (for reference, 802.11 Wi-Fi networks are commonly operating at 2.4 GHz, the same frequency as some cordless phones, microwave ovens and Bluetooth devices).

Certified Wireless USB allows up to 127 devices to connect directly to the USB foot.

USB is possible without the use of hubs although hubs may be used, for example to emulate the USB 2.0 protocol. For example, the WUSB foot may comprise a host wire adapter or a device wire adapter for adding WUSB capability to a computer or other device. In the case that the WUSB foot comprises a host wire adapter, a corresponding device wire adapter can be used to connect various devices via USB cable to the device wire adapter and to communicate wirelessly to the host wire adapter of the WUSB foot. In the case that the WUSB foot comprises a device wireless adapter, the WUSB foot is configured to communicate with a WUSB host, such as a notebook or computer and various USB capable devices can be connected to the WUSB foot via a USB connection cable. The WUBS foot may also comprise both a host wire adapter and a device wire adapter.

In particular, in situations where the distance between the WUSB foot and a corresponding WUSB capable device is less than 10 m or 33 ft. A performance of 50-100 Mbps can be achieved which decreases with distance. According to the application, the circuit of the WUSB foot may be configured to limit the bitrate for power saving purposes.

According to a further embodiment, a foot according to the application is equipped with a global positioning system (GPS) software and a GPS receiver. The GPS software may further comprise a streets and tips software. By providing a GPS software and GPS receiver in the foot, a system unit to which the foot is attached can be provided with GPS functionality and is made capable of sending position data. Moreover, the GPS functionality is available even when the device is powered off.

The USB foot may be provided with a USB, a Firewire or other cable connection or with a wireless personal area network (WPAN), such as Bluetooth, for transferring data between the USB foot and the system unit. The data may include display data for display on a screen, updates for a streets and tips database and so forth.

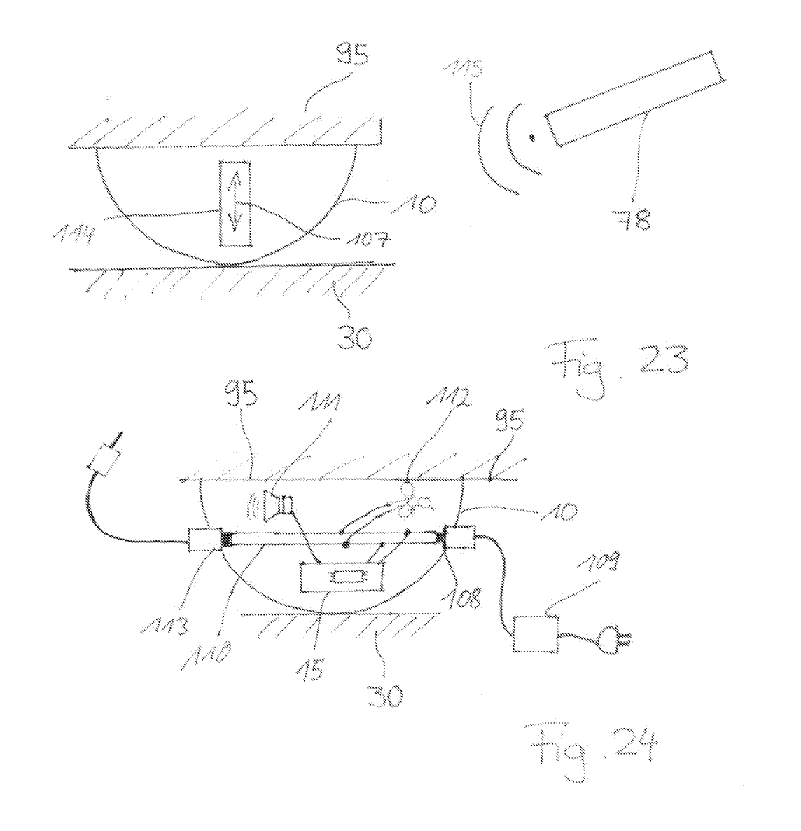

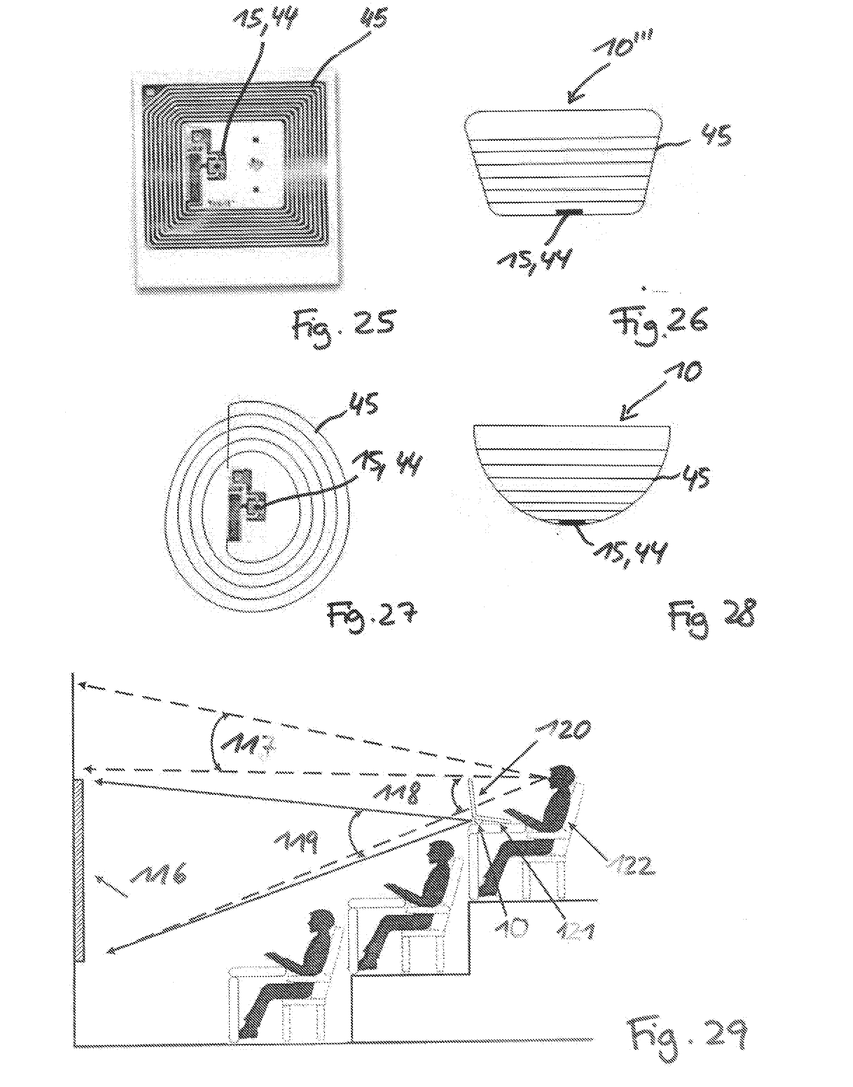

FIGS. 25 and 26 show an attachable support 10″′ according to the application with an integrated circuit 15, also referred to as integrated circuit 44, and the loop antenna 45. FIG. 25 shows a top view into a compartment of a casing of the attachable support 10″′. FIG. 26 shows a schematic side view of the attachable support 10″′. According to the embodiment of FIGS. 25, 26, the integrated circuit 15 is provided at the bottom of the compartment and loops of the loop antenna are stacked in regular distances across the height of the attachable support 10″′. The loops may be essentially horizontal and connected via short segments of conducting material or they may also be formed as an ascending spiral. The foot or attachable support 10″′ provides a sufficient distance such that the loop antenna can be reached by a signal of an RFID reader, either directly or via reflections, especially if the foot is provided close to an edge of a bottom surface of an equipment.

The embodiment of FIGS. 25, 26 shows an RFID foot 10″′ in the shape of a frustum with an essentially square shaped base surface. FIGS. 27, 28 show a similar RFID foot 10 which is in the shape of a half-sphere. The parts of the foot 10′″ are similar to the parts of the foot 10, which are shown in detail in FIGS. 2 and 3. The antenna loops extend over at least two third of the height of the RFID foot 10″′. To obtain a good reception for a loop antenna with a horizontal orientation, as shown in FIGS. 25 and 26, it is advantageous if the antenna loops extend over at least half the height of the foot.

FIG. 29 illustrates how the position and/or height of an attachable support 10 according to the application affects an ergonomic position of an equipment, especially of a notebook. FIG. 29 shows, among others, a projection screen 116, a first angle of sight 117 above the notebook, a second angle of sight 118 below 117, an angle of projection 119 of a mini-projector, a notebook screen 120, a notebook bottom part 121, a backrest 122 of a chair.

According to the application, a foot height of at least 1 cm of the attachable support 10 is advantageous for allowing the passage of air and to provide an ergonomic position for the keyboard. A foot height of at least 2 cm provides an even better circulation of air below the notebook and a good accessibility to an internal antenna of the foot by radio waves of an RFID reader. A foot height of at least 3 cm further improves the air circulation and the accessibility to radio waves and provides in addition a good position for a mini projector or a camera which can be integrated into the foot or in the notebook such that the angle of projection 119 does not intersect with a table surface on which the notebook rests. A user of the notebook may use the mini-projector to hold presentations or use a camera which is integrated in the foot 10 to take lecture notes which are then stored in a flash memory of the foot 10. Referring back to FIG. 2, a lens of the camera or projector may be provided in the cup 21, for example and the camera or projector may be provided on top of a circuit board of the integrated circuit 15. An orientation of the lens can be made variable such as to provide a desired sight angle or projection angle.

A half-spherical surface of the foot 10 is especially advantageous as it can be shifted to a position that results in a desired inclination of the notebook. In the example of FIG. 29, this desired position depends on factors such as the users height, the backrest inclination, the table height and the position of the projection screen 116.

Although the above description contains much specificity, this should not be construed as limiting the scope of the embodiments but merely providing illustration of the foreseeable embodiments. The above stated advantages of the embodiments should not be construed especially as limiting the scope of the embodiments but merely to explain possible achievements if the described embodiments are put into practice. Thus, the scope of the embodiments should be determined by the claims and their equivalents, rather than by the examples given.

The embodiments can also be described with the following lists of elements being organized into items. The respective combinations of features which are disclosed in the item list are regarded as independent subject matter, respectively, that can also be combined with other features of the application.

1. An attachable support for attachment to a bottom surface of an equipment, the attachable support comprising a casing for supporting a weight of the equipment, the casing comprising
an attachment portion for securing the attachable support to the bottom surface of the equipment,
a first casing portion and a second casing portion, the first casing portion and the second casing portion forming a compartment of the casing, wherein the compartment is located below the attachment portion, and wherein the compartment houses an electric circuit and a communication means, the communication means being connected to the electric circuit, wherein the electric circuit provides a cooperation with the equipment, wherein a height of the attachable support is at least 1 cm.

2. The attachable support according to item 1, wherein a height of the attachable support is at least 2 cm.

3. The attachable support according to item 1, wherein a height of the attachable support is at least 3 cm.

4. The attachable support according to one of the preceding items, wherein the second casing portion is provided below the first casing portion.

5. The attachable support according to one of the preceding items, wherein the attachment portion is formed out as an integral part on the first portion of the casing.

6. The attachable support according to one of the preceding items, wherein the attachment portion comprises a threaded portion.

7. The attachable support according to one of the preceding items, wherein the attachment portion comprises a snap-on part.

8. The attachable support according to one of the preceding items, wherein the attachment portion comprises a magnet.

9. The attachable support according to one of the preceding items, wherein the attachment portion is provided as a separate part that is connected to the first portion of the casing.

10. The attachable support according to one of the preceding items, wherein the first casing portion is welded to the second casing portion.

11. The attachable support according to one of the preceding items, wherein the first casing portion is glued to the second casing portion.

12. The attachable support according to one of the preceding items, wherein the first casing portion is connected to the second casing portion by a snap fit.

13. The attachable support according to one of the preceding items, wherein
a bottom surface of the casing is curve shaped.

14. The attachable support according to item 13, wherein the curve shaped bottom surface is formed as a half-spherical bottom portion.

15. The attachable support according to one of the preceding items, wherein the casing is shaped as a cylinder.

16. The attachable support according to one of the preceding items wherein
the casing has essentially the shape of an elongated box.

17. The attachable support according to item 16, wherein a length of the elongated box is at least 10 cm.

18. The attachable support according to item 17, wherein the elongated box comprises sockets for the connection of electrical devices, the sockets being connected to the electric circuit.

19. The attachable support according to one of the preceding items, the attachable support comprising an output jack that is connected to the electric circuit, wherein the electric circuit is configured to exchange information between the attachable support and the equipment via the output jack.

20. The attachable support according to one of the preceding items, wherein the electric circuit comprises an RFID tag unit, the RFID tag unit being located in the compartment, the attachable support further comprising an antenna, the antenna being connected to the RFID tag unit, the compartment of the attachable support further comprising a memory that is connected to the RFID tag unit, wherein a cooperation with the equipment is provided by an identity information of the equipment that is stored in the memory.

21. The attachable support according to one of the preceding items, wherein a memory that is connected to the electric circuit comprises an erasable RAM, the erasable RAM comprising identification information of the equipment.

22. The attachable support according to one of the items 20 or 21, wherein the circuit comprises a clock and wherein the circuit is configured to send an identification signal in pre-determined time intervals, based on the identification information in the memory and on a timer signal of the clock.

23. The attachable support according to one of the items 20 to 22, wherein the attachable support comprises an external antenna which protrudes from the attachable support.

24. The attachable support according to one of the items 20 to 23, wherein the attachable support comprises an internal antenna which is enclosed by the compartment.

25. The attachable support according to one of the preceding items, the attachable support comprising one or more control lamps for indicating a state of the electric circuit and the casing comprising openings for the one or more control lamps.

26. The attachable support according to one of the preceding items, wherein the attachable support comprises a loudspeaker which is connected to the circuit.

27. The attachable support according to one of the preceding items, wherein
the compartment of the attachable support houses an electrical power supply which is connected to the circuit.

28. The attachable support according to one of the preceding items, wherein the attachable support comprises an input jack for an external power supply, the input jack being connected to the electric circuit.

29. The attachable support according to one of the preceding items, the attachable support comprising pockets for the insertion of electronic devices, wherein the pockets are electrically connected to the circuit.

30. An equipment comprising
an attachable support according to one of the preceding items for supporting the equipment, wherein the attachable support is fixed to a bottom surface of the equipment.

31. A communication system, the communication system comprising
an equipment according to item 30 and
a reader, wherein
   the reader is configured to communicate with the RFID tag unit via a first wireless communication protocol and the reader is configured to communicate with a computing system via a second wireless communication protocol.

Reference Numbers

| | |
|---|---|
| 10, 10′, 10″ | RFID foot |
| 12 | housing |
| 13 | RFID device |
| 15 | integrated circuit |
| 16 | antenna |
| 19 | top cap |
| 20 | cover |
| 21 | cup |
| 22 | bottom base |
| 24 | top surface |
| 25 | bottom surface |
| 26 | recess |
| 28 | sidewall |
| 30 | top part |
| 32 | bottom surface |
| 34 | top rim |
| 36 | recess |
| 37 | bottom part |
| 39 | top recess |
| 42 | passive RFID module |
| 44 | integrated circuit |
| 45 | antenna |
| 47 | active RFID module |
| 49 | integrated circuit |
| 51 | battery |
| 52 | antenna |
| 55 | WiFi device |
| 57 | printer |
| 59 | bottom surface |
| 60 | computer tablet |
| 62 | bottom surface |
| 63 | laptop |
| 65 | bottom surface |
| 66 | scanner |
| 68 | bottom surface |
| 69 | projector |
| 71 | bottom surface |
| 72 | Hi-Fi sound system |
| 75 | RFID data interface |
| | diagram |
| 77 | RFID reader |
| 78 | RFID reader |
| 80 | local software infrastructure |
| 82 | enterprise resource |
| | planning |
| 83 | supply chain management |
| 84 | room |
| 85 | chair |
| 86 | table |
| 87 | lamp |
| 90 | kitchen |
| 92 | wine refrigerator |
| 93 | microwave oven |
| 94 | rice cooker |
| 95 | bottom surface |
| 96 | inner thread |
| 97 | screw |
| 98 | opening |
| 100 | convex part |
| 101 | protrusion |
| 102 | protrusion |
| 103 | guiding channel |
| 104 | cavity |
| 105 | external antenna |
| 106 | threaded opening |
| 107 | external antenna |
| 108 | jack |
| 109 | transformer |
| 110 | cable |
| 111 | loudspeaker |
| 112 | fan |
| 113 | jack |
| 114 | RFID antenna |
| 115 | reader signal |
| 116 | projection screen |
| 117 | angle of sight |
| 118 | angle of sight |
| 119 | angle of projection |
| 120 | notebook screen |
| 121 | notebook bottom part |
| H | height |
| W | width |

1. An attachable support for attachment to a bottom surface of an equipment, the attachable support comprising a casing for supporting a weight of the equipment, the casing comprising
an attachment portion for securing the attachable support to the bottom surface of the equipment,
a first casing portion and a second casing portion, the first casing portion and the second casing portion forming a compartment of the casing, wherein the compartment is located below the attachment portion, and wherein the compartment houses an electric circuit and a communication means, the communication means being connected to the electric circuit, wherein the electric circuit provides a cooperation with the equipment, wherein a height of the attachable support is at least 1 cm.

2. The attachable support according to claim 1, wherein a height of the attachable support is at least 2 cm.

3. The attachable support according to claim 1, wherein a height of the attachable support is at least 3 cm.

4. The attachable support according to claim 1, wherein the second casing portion is provided below the first casing portion.

5. The attachable support according to claim 1, wherein the attachment portion is formed out as an integral part on the first portion of the casing.

6. The attachable support according to claim 1, wherein the attachment portion comprises a threaded portion.

7. The attachable support according to claim 1, wherein the attachment portion comprises a snap-on part.

8. The attachable support according to claim 1, wherein the attachment portion comprises a magnet.

9. The attachable support according to claim 1, wherein the attachment portion is provided as a separate part that is connected to the first portion of the casing.

10. The attachable support according to claim 1, wherein the first casing portion is welded to the second casing portion.

11. The attachable support according to claim 1, wherein the first casing portion is glued to the second casing portion.

12. The attachable support according to claim 1, wherein the first casing portion is connected to the second casing portion by a snap fit.

13. The attachable support according to claim 1, wherein a bottom surface of the casing is curve shaped.

14. The attachable support according to claim 13, wherein the curve shaped bottom surface is formed as a half-spherical bottom portion.

15. The attachable support according to claim 1, wherein the casing is shaped as a cylinder.

16. The attachable support according to claim 1 wherein the casing has essentially the shape of an elongated box.

17. The attachable support according to claim 16, wherein a length of the elongated box is at least 10 cm.

18. The attachable support according to claim 17, wherein the elongated box comprises sockets for the connection of electrical devices, the sockets being connected to the electric circuit.

19. The attachable support according to claim 1, the attachable support comprising an output jack that is connected to the electric circuit, wherein the electric circuit is configured to exchange information between the attachable support and the equipment via the output jack.

20. The attachable support according to claim 1, wherein the electric circuit comprises an RFID tag unit, the RFID tag unit being located in the compartment, the attachable support further comprising an antenna, the antenna being connected to the RFID tag unit, the compartment of the attach able support further comprising a memory that is connected to the RFID tag unit, wherein a cooperation with the equipment is provided by an identity information of the equipment that is stored in the memory.

21. The attachable support according to claim 1, wherein a memory that is connected to the electric circuit comprises an erasable RAM, the erasable RAM comprising identification information of the equipment.

22. The attachable support according to claim 20, wherein the circuit comprises a clock and wherein the circuit is configured to send an identification signal in pre-determined time intervals, based on the identification information in the memory and on a timer signal of the clock.

23. The attachable support according to claim 20, wherein the attachable support comprises an external antenna which protrudes from the attachable support.

24. The attachable support according claim 20, wherein the attachable support comprises an internal antenna which is enclosed by the compartment.

25. The attachable support according to claim 1, the attachable support comprising one or more control lamps for indicating a state of the electric circuit and the casing comprising openings for the one or more control lamps.

26. The attachable support according to claim 1, wherein the attachable support comprises a loudspeaker which is connected to the circuit.

27. The attachable support according to claim 1, wherein the compartment of the attachable support houses an electrical power supply which is connected to the circuit.

28. The attachable support according to claim 1, wherein the attachable support comprises an input jack for an external power supply, the input jack being connected to the electric circuit.

29. The attachable support according to claim 1, the attachable support comprising pockets for the insertion of electronic devices, wherein the pockets are electrically connected to the circuit.

30. An equipment comprising
an attachable support according to claim 1 for supporting the equipment, wherein the attachable support is fixed to a bottom surface of the equipment.

31. A communication system, the communication system comprising
an equipment according to claim 30 and
a reader, wherein
the reader is configured to communicate with the RFID tag unit via a first wireless communication protocol and the reader is configured to communicate with a computing system via a second wireless communication protocol.
